(19) United States
(12) Patent Application Publication
(10) Pub. No.: US 2014/0306440 A1
(43) Pub. Date: Oct. 16, 2014

(54) Left Handed Checks

(71) Applicant: Stanislaw Franczykowski, Brick, NJ (US)

(72) Inventor: Stanislaw Franczykowski, Brick, NJ (US)

(21) Appl. No.: 13/861,504

(22) Filed: Apr. 12, 2013

(51) Int. Cl. B42D 5/02; B42D 5/00

(52) U.S. Cl. CPC B42D 5/022; B42D 5/002
USPC 281/27.1; 402/79

(57) ABSTRACT

A left-handed checkbook device is disclosed that makes it possible for left-handed users to write checks from a ringed binder without discomfort. The left-handed checkbook device comprises a plurality of check blanks and check receipts which comprise a plurality of binder holes which are positioned on the right end of each check receipt. The plurality of check blanks can also comprise a plurality of perforations positioned on the right end of each check blank, between the check blank and the check receipt, for removing the check blanks from the binder. The plurality of check blanks are secured within a binder via a plurality of binder rings. The plurality of check blanks are positioned on a left side of the binder with a front surface of the plurality of check blanks exposed, such that a left-handed person can easily utilize the check blanks without contacting the binder rings of the binder.

### CROSS-REFERENCE

This application claims priority from Provisional Patent Application Ser. No. 61/640,858 filed May 1, 2012.

### BACKGROUND

A business check-book is typically kept in a multiple ring business binder. The check blanks and check stubs (or receipts) are usually positioned on the right side of the binder rings for ease of use by right-handed individuals. Unfortunately, this orientation makes it difficult for left-handed individuals to efficiently use the binders for filling out checks. With the rings to the left of the check blanks and check stubs, left-handed users cannot move their left wrist sufficiently to write. Thus, left-handed users must take much longer to fill out a check, or write the check with cramped and messy hand-writing. Accordingly, the left-handed users may be discouraged from writing checks or check receipts as often because it is a difficult and frustrating process. An effective solution is necessary.

There is a need for a device that makes it possible for left-handed individuals to write checks or check receipts from a multiple ring binder book without discomfort and without having to remove the check and the check receipt from the binder, which could be time consuming and result in loss of the check and/or receipt. The present invention's functional design positions the rings to the right of the check and check receipt, providing adequate space for wrist-movement by a left handed individual while writing. This innovative design makes business transactions more efficient for left-handed individuals, by saving them time and energy while writing checks and check receipts. Using this device will also feel more natural and comfortable for left-handed individuals. Further, this device ensures that any individual, regardless of hand dominance, can perform important business functions efficiently.

### SUMMARY

The following presents a simplified summary in order to provide a basic understanding of some aspects of the disclosed innovation. This summary is not an extensive overview, and it is not intended to identify key/critical elements or to delineate the scope thereof. Its sole purpose is to present some concepts in a simplified form as a prelude to the more detailed description that is presented later.

The subject matter disclosed and claimed herein, in one aspect thereof, comprises a left-handed checkbook device that makes it possible for left-handed users to write checks from a ringed binder without discomfort. The left-handed checkbook device comprises a plurality of check blanks removably secured to a plurality of check receipts, wherein each of the check blanks and check receipts comprises a right end, a left end, and opposing top and bottom ends. Furthermore, the plurality of check blanks and check receipts comprise a plurality of binder holes which are positioned on the right end of each check receipt. The plurality of check blanks can also comprise a plurality of perforations positioned on the right end of each check blank, between the check blank and the check receipt, and adjacent to the plurality of binder holes, for removing the check blanks from the binder, but leaving the check receipts (stubs).

In a preferred embodiment, the plurality of check blanks and check receipts are secured within a binder via a plurality of binder rings. Specifically, the plurality of check blanks are secured within the binder by engaging the plurality of binder holes with the plurality of binder rings, such that the plurality of check blanks and attached stubs are positioned to the left of the binder rings. The plurality of check blanks are positioned on the left side of the binder with a front surface of the plurality of check blanks facing up (or exposed), such that a left-handed person can easily utilize the check blanks without contacting the binder rings of the binder.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and is intended to include all such aspects and their equivalents. Other advantages and novel features will become apparent from the following detailed description when considered in conjunction with the drawings.

### BRIEF DESCRIPTION OF THE DRAWINGS

FIG. 1 illustrates a top view of the left-handed checkbook device in accordance with the disclosed architecture.

FIG. 2 illustrates a perspective view of the left-handed checkbook device secured within a binder in accordance with the disclosed architecture.

FIG. 3A illustrates a perspective view of a stack of left-handed check blanks in accordance with the disclosed architecture.

FIG. 3B illustrates a perspective view of a plurality of left-handed check blanks secured within a binder in accordance with the disclosed architecture.

FIG. 4 illustrates a perspective view of the left-handed checkbook device in use in accordance with the disclosed architecture.

FIG. 5 illustrates a perspective view of a left-handed user utilizing a prior art checkbook device in accordance with the disclosed architecture.

### DESCRIPTION OF PREFERRED EMBODIMENTS

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof.

A left-handed checkbook device is disclosed that makes it possible for left-handed users to write checks from a binder book without discomfort and without having to remove the checks and stubs from the binder. The functional design of the left-handed checkbook device positions the binder rings to the right of the checks, providing adequate space for wrist-movement while writing. This device makes business transactions more efficient for left-handed individuals, by saving them time and energy while writing checks. Additionally, the device ensures that any individual, regardless of hand dominance, can perform important business functions efficiently.

The left-handed checkbook device comprises a plurality of check blanks and check receipts which comprise a plurality of binder holes which are positioned on the right end of each check receipt. The plurality of check blanks can also comprise a plurality of perforations positioned on the right end of each check blank, between the check blank and the check receipt, which are for removing the check blanks from the binder, but retaining the check receipts. The plurality of check blanks and check receipts are secured within a binder via a plurality of binder rings. The plurality of check blanks and check receipts are positioned on a left side of the binder with a front surface of the plurality of check blanks facing up, such that a left-handed person can easily utilize the check blanks without contacting the binder rings of the binder.

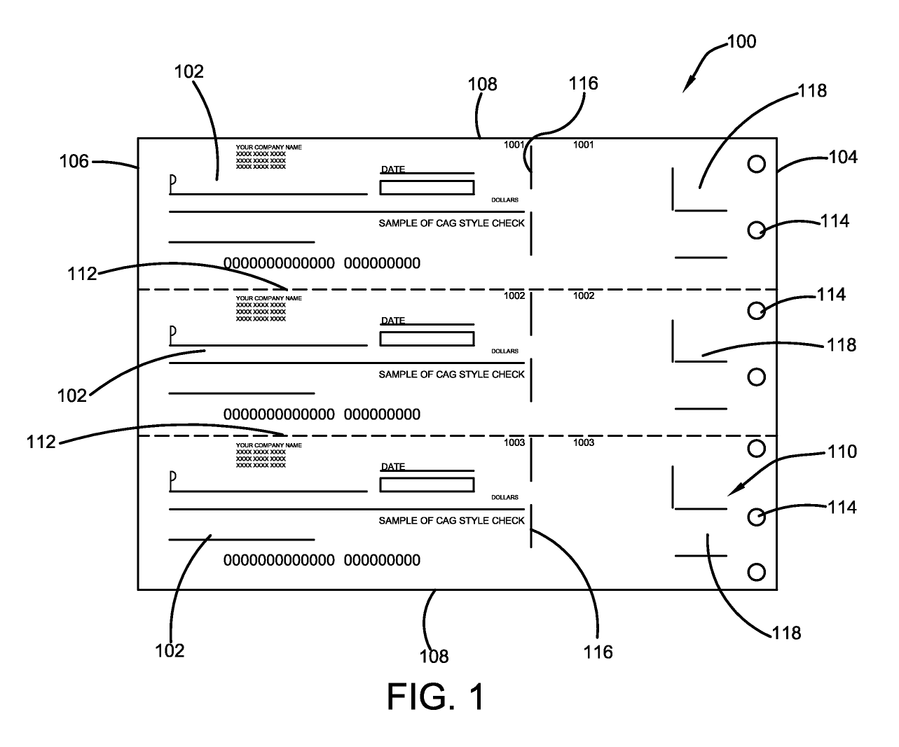

Referring initially to the drawings, FIGS. 1-2 and 3A-B illustrate a left-handed checkbook device 100 that makes it possible for left-handed users to write checks from a ringed binder without discomfort. The left-handed checkbook device 100 comprises a plurality of check blanks 102, wherein each of the check blanks 102 comprises a right end 104, a left end 106, opposing top and bottom ends 108, and a front surface 110 and a back surface (not shown). Typically, the check blanks 102 are rectangular in shape, however any other suitable shape can be used as is known in the art without affecting the overall concept of the invention.

The check blanks 102 would generally be constructed of paper, cardboard, check paper, etc., though any other suitable material may be used to manufacture the check blanks 102 as is known in the art without affecting the overall concept of the invention. The check blanks 102 can also comprise a variety of colors, designs, and security measures to suit user and manufacturing preference. The check blanks 102 are approximately between 10½ and 12½ inches long as measured from the right end 104 to the left end 106, and approximately between 8 and 9 inches wide as measures from opposing top and bottom ends 108.

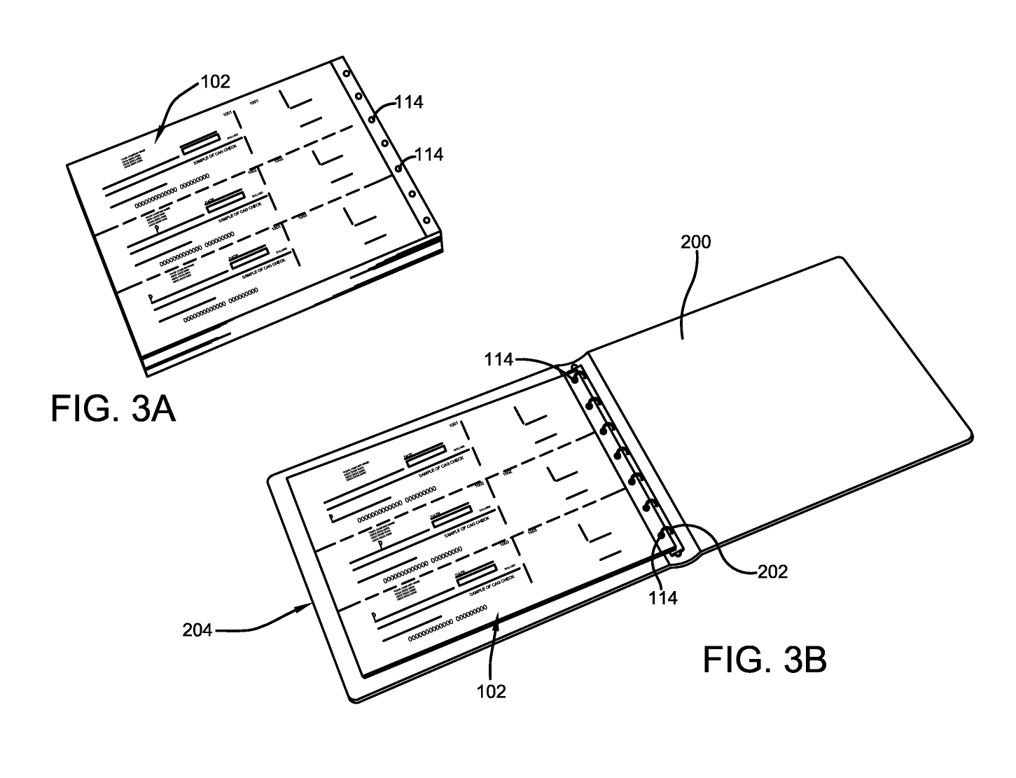

The plurality of check blanks 102 are removably attached together, and are removably attached to a corresponding check stub/receipt 118. Typically, the check blanks 102 are removably attached together via perforations 112, but can be removably attached together via any other suitable securing means as is known in the art. The plurality of check blanks 102 are typically attached together at their opposing top and bottom ends 108. For example, the bottom end 108 of a first check blank 102 is attached to the top end 108 of a second check blank 102, and the bottom end 108 of the second check blank 102 is attached to the top end 108 of a third check blank 102, to form a continuous sheet (as shown in FIG. 1). The continuous sheets can then be stacked together, one on top of another with the right ends 104 and left ends 106 of the check blanks 102 aligned (as shown in FIG. 3A).

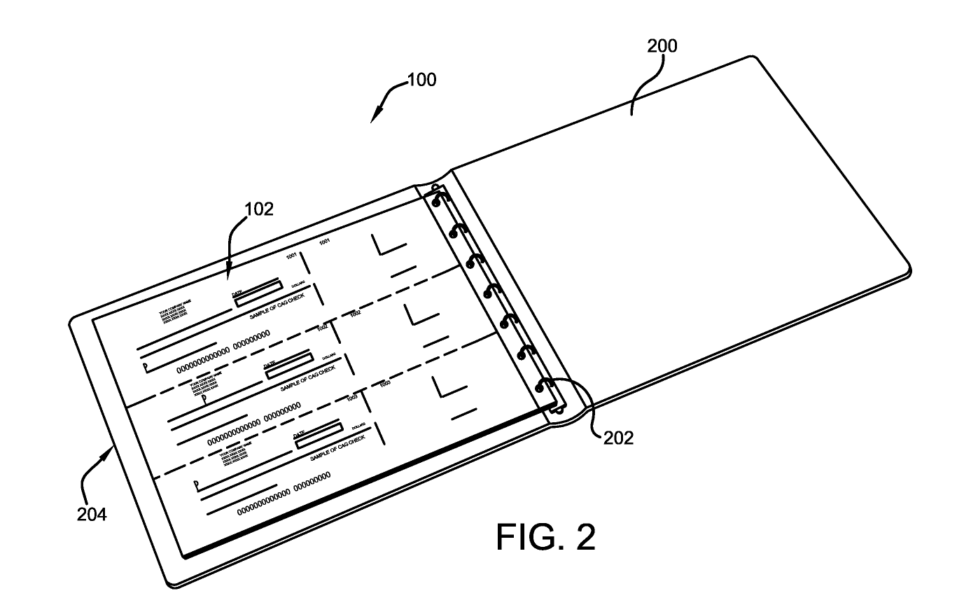

Furthermore, the continuous sheet of check blanks 102 comprise a plurality of binder holes 114 which are positioned on the right end 104 of each check receipt 118. Typically, each check blank 102 comprises at least a pair of binder holes 114 on the right end 104 of the check receipt 118, however any other suitable continuous opening as is known in the art can be utilized as long as it will engage with and allow the check blanks 102 to secure in a binder 200. Further, any suitable number of binder holes 114 can be utilized as is known in the art, as long as the continuous sheet of check blanks 102 can be secured in a binder 200 (as shown in FIG. 2 and FIG. 3B).

Additionally, the continuous sheet of check blanks 102 comprise a plurality of perforations 116 positioned on the right end 104 of each check blank 102, between the check blank 102 and the check receipt 118, and adjacent to the plurality of binder holes 114. The plurality of perforations 116 allow the check blanks 102 to be removed from the binder 200, while leaving the check stubs 118 (or receipts) attached in the binder 200. Typically, perforations 116 are used, but any other suitable securing means can be used as is known in the art, as long as the check blanks 102 can be easily removed from the binder 200.

The plurality of check blanks 102 are secured within a binder 200 via a plurality of binder rings 202. The plurality of check blanks 102 are secured within the binder 200 by engaging the plurality of binder holes 114 with the plurality of binder rings 202, such that the plurality of check blanks 102 are positioned on a left side 204 of the binder rings 202. When placed in the binder 200, the plurality of check blanks 102 are positioned on the left side 204 of the binder 200 with a front surface 110 of the plurality of check blanks 102 facing up (or exposed), such that a left-handed person can easily utilize the check blanks 102 without contacting the binder rings 202 of the binder 200 (as shown in FIG. 2 and FIG. 3B).

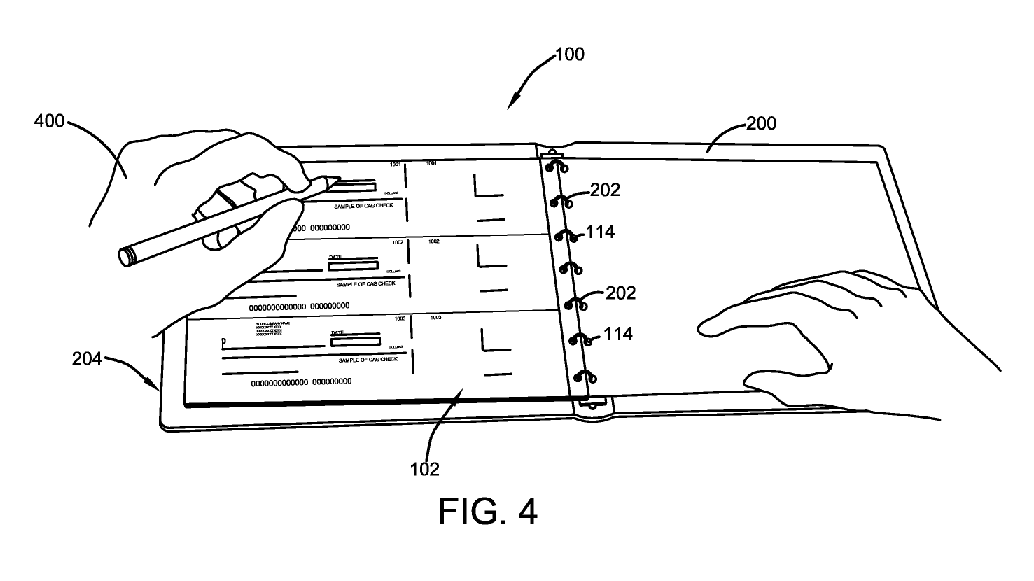

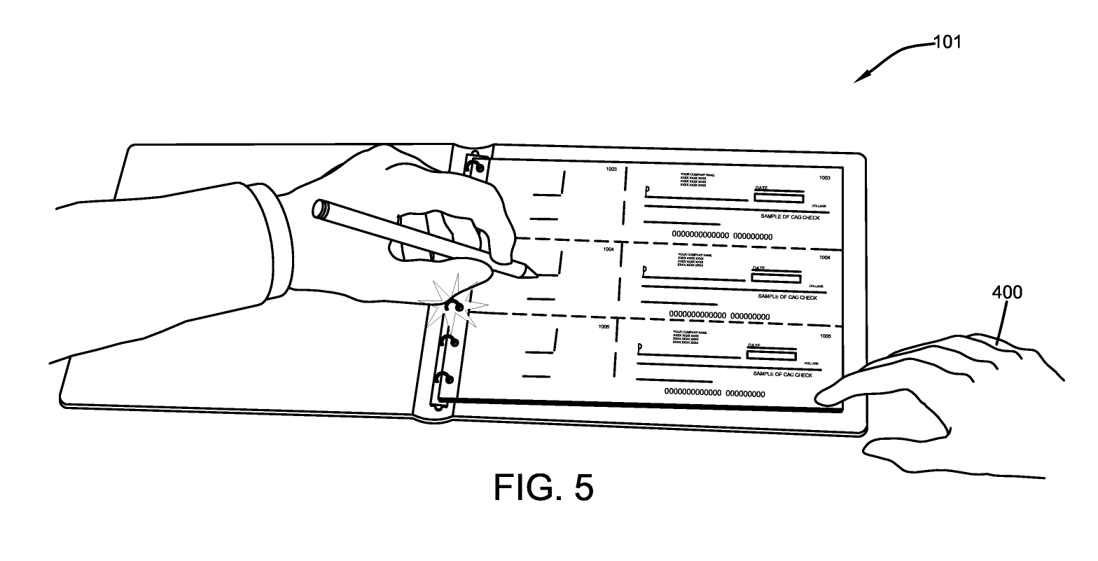

FIG. 4 illustrates the left-handed checkbook device 100 in use and FIG. 5 illustrates a left-handed user 400 utilizing a prior art checkbook device. In operation, a user 400 would choose the color and/or specific design of the plurality of check blanks 102 that meets their needs and/or wants. The user 400 would then choose the color and/or specific design of the binder 200 that meets their needs and/or wants. The user 400 would then open the binder 200, such that the binder 200 lays flat upon a table or other horizontal surface. The user 400 then opens the binder rings 202 by grasping each ring and pulling the rings apart until they remain in an open position.

Once the binder rings 202 are open, the user then aligns the binder rings 202 with the binder holes 114 on the plurality of check stubs 118, such that the binder rings 202 engage the binder holes 114 (as shown in FIG. 4). Specifically, the binder rings 202 are threaded through the binder holes 114. Once the binder rings 202 are threaded through the binder holes 114, the binder rings 202 are then closed, securing the plurality of check blanks 102 and check stubs 118 within the binder 200. Typically, the binder rings 202 are closed by pushing the rings together until they meet, end to end. Once the plurality of check blanks 102 and check stubs 118 are secured within the binder 200, the left-handed user 400 can then utilize the check blanks 102 and check stubs 118 as usual, without having to write over the binder rings 202 (prior art checkbook 101—shown in FIG. 5).

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A left-handed checkbook device, comprising:
a plurality of check blanks each comprising a right end, a left end, and opposing top and bottom ends; and
a plurality of check stubs removably attached to the plurality of check blanks;
wherein the plurality of check blanks are removably attached together; and
wherein a plurality of binder holes are positioned on a right end of each check stub.

2. The left-handed checkbook device of claim 1, wherein the plurality of check blanks are removably attached together via perforations.

3. The left-handed checkbook device of claim 1, wherein a plurality of perforations are positioned on the right end of each check blank, between the check blank and the check stub, and adjacent to the plurality of binder holes.

4. The left-handed checkbook device of claim 1, wherein the plurality of check blanks are secured within a binder via a plurality of binder rings.

5. The left-handed checkbook device of claim 4, wherein the plurality of check blanks are secured within the binder by engaging the plurality of binder holes with the plurality of binder rings, such that the plurality of check blanks are positioned on a left side of the plurality of binder rings.

6. The left-handed checkbook device of claim 5, wherein the plurality of check blanks are positioned on the left side of the plurality of binder rings with a front surface of the plurality of check blanks exposed.

7. The left-handed checkbook device of claim 1, wherein the plurality of check blanks are approximately 12½ inches in length and 9 inches in width.

8. The left-handed checkbook device of claim 1, wherein the plurality of check blanks are manufactured from at least one of paper, cardboard, or check paper.

9. A left-handed checkbook system, comprising:
a plurality of left-handed check blanks each comprising a right end, a left end, and opposing top and bottom ends;
a plurality of check stubs removably attached to the plurality of check blanks; and
a binder; and
wherein a plurality of binder holes are positioned on a right end of each check stub.

10. The left-handed checkbook system of claim 9, wherein a plurality of perforations are positioned on the right end of each check blank, between the check blank and the check stub, and adjacent to the plurality of binder holes.

11. The left-handed checkbook system of claim 9, wherein the plurality of check blanks are removably attached together via perforations.

12. The left-handed checkbook system of claim 9, wherein the plurality of check blanks are secured within a binder via a plurality of binder rings.

13. The left-handed checkbook system of claim 12, wherein the plurality of check blanks are secured within the binder by engaging the plurality of binder holes with the plurality of binder rings, such that the plurality of check blanks are positioned on a left side of the plurality of binder rings.

14. The left-handed checkbook system of claim 13, wherein the plurality of check blanks are positioned on the left side of the plurality of binder rings with a front surface of the plurality of check blanks exposed.

15. The left-handed checkbook system of claim 9, wherein the plurality of check blanks are approximately 12½ inches in length and 9 inches in width.

16. The left-handed checkbook system of claim 9, wherein the plurality of check blanks are manufactured from at least one of paper, cardboard, or check paper.

17. A left-handed checkbook system, comprising:
a plurality of left-handed check blanks each comprising a right end, a left end, and opposing top and bottom ends;
a plurality of check stubs removably attached to the plurality of check blanks; and
a binder; and
wherein a plurality of binder holes are positioned on a right end of each check stub; and
a plurality of perforations are positioned on the right end of each check blank, between the check blank and the check stub, and adjacent to the plurality of binder holes.

18. The left-handed checkbook system of claim 17, wherein the plurality of check blanks are secured within a binder via a plurality of binder rings.

19. The left-handed checkbook system of claim 18, wherein the plurality of check blanks are secured within the binder by engaging the plurality of binder holes with the plurality of binder rings, such that the plurality of check blanks are positioned on a left side of the plurality of binder rings.

20. The left-handed checkbook system of claim 19, wherein the plurality of check blanks are positioned on the left side of the plurality of binder rings with a front surface of the plurality of check blanks exposed.
